(19) United States
(12) Patent Application Publication
(10) Pub. No.: US 2006/0287005 A1
(43) Pub. Date: Dec. 21, 2006

(54) Network support for lost call alerting

(76) Inventors: David S. Benco, Winfield, IL (US); Sanjeev Mahajan, Naperville, IL (US); Baoling S. Sheen, Naperville, IL (US); Sandra L. Truc, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/157,997

(22) Filed: Jun. 21, 2005

(51) Int. Cl. H04B 1/38

(52) U.S. Cl. 455/567; 455/423

(57) ABSTRACT

An apparatus in one example has: lost call alerting functionality in a communication network that later alerts a mobile terminal of calls which could not be delivered because the mobile terminal was located in an area of RF degradation when the delivery of the call was attempted; and a storage for lost call data in the communication network.

### TECHNICAL FIELD

The invention relates generally to telecommunication networks, and more particularly to lost call alerting.

### BACKGROUND

Currently, when a mobile phone or standard phone receives an incoming call unanswered by the user, information for the incoming call is often displayed in a liquid crystal display. For example, when the user of the mobile phone does not respond, the telephone number of the calling party is displayed on the liquid crystal display.

One known method for notifying and reminding phone users of missed calls is characterized in that when a cell phone receives a call that remains unanswered by the user, the cell phone periodically notifies and subsequently reminds the user in a time period interval, in a manner specified by the user.

In another known method for notifying and reminding phone users of missed calls, when a call is not answered, the cell phone periodically notifies and subsequently reminds the user within a maximum time period until the user checks the call information. The duration of the time period and the maximum time are predetermined. The procedure is terminated at the end of the maximum time when the missed call is not checked by the user.

Presently, a network cannot alert a mobile terminal (such as a cell phone) of a mobile subscriber of calls which could not be delivered because the mobile terminal was located in a bad coverage area (i.e., “RF hole”). These lost calls do not show up in the missed calls list that is available to the mobile terminal.

Several mechanisms are available to contact the mobile terminals of mobile subscribers (voice, SMS (short message service), voice mail, etc.). However, when the mobile terminal is not located in an area of good RF (radio frequency) coverage, the delivery of each of these mechanisms fail. While SMS message delivery can be re-tried and voice mail can be retrieved at a later time by the mobile subscriber, calls missed due to poor RF conditions are lost without any notification if the caller does not leave a voice message. It is not uncommon for a caller to be unable to leave a voice message for several reasons (e.g., called party's voice mailbox is full, etc.). It is very frustrating in these circumstances to be unable to reach a subscriber as well as being unable to leave a voice message. Also, it may be some time before the voice mailbox blockage is removed. Under these conditions, a mobile subscriber would be oblivious to a very important call, which is not acceptable.

Thus, there is a need in the art for an improved method and apparatus for lost call alerting.

### SUMMARY

The invention in one implementation encompasses an apparatus. The apparatus comprises a network service provider; lost call alerting functionality in a communication network that later alerts a mobile terminal of calls which could not be delivered because the mobile terminal was located in an area of RF degradation when the delivery of the call was attempted; and a storage for lost call data in the communication network.

The invention in a further implementation encompasses a method. The method comprises: storing in a communication network lost call data for failed call attempts to a mobile terminal due to degraded RF (radio frequency) conditions; detecting when RF conditions for the mobile terminal improve; and transmitting, by the communication network, the lost call data to the mobile terminal.

### DESCRIPTION OF THE DRAWINGS

Features of exemplary implementations of the invention will become apparent from the description, the claims, and the accompanying drawings in which:

FIG. 1 is a representation of one implementation of an apparatus that provides network support for lost call alerting;

FIG. 2 is a representation of one exemplary flow diagram for lost call alerting according to the present method; and

FIG. 3 is another representation of one exemplary flow diagram for lost call alerting according to the present method.

### DETAILED DESCRIPTION

Embodiments of the present apparatus and method provide for the network to log and store failed call attempts due to degraded RF conditions (“lost calls”). The network may detect when the called mobile terminal's RF conditions improve. The network may then transmit the lost call data (for example, calling number) to the called party.

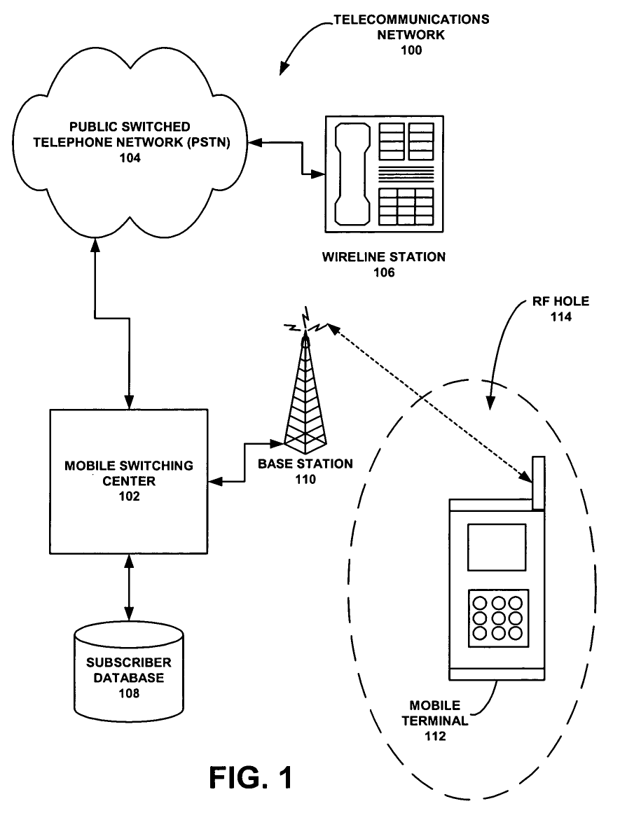

FIG. 1 is a representation of one implementation of an apparatus that provides network support for lost call alerting.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 may be operatively coupled to a wireline station 106. The PSTN 104 may route calls to and from a mobile terminal 112 through the MSC 102. The MSC 102 may also be connected to at least one base station (BS) 110. The base station 110 communicates with the mobile terminal 112 in its service area using a subscriber database 108. The PSTN 104 generally may be implemented as a worldwide voice telephone network accessible to all those with telephones and access privileges (e.g., AT&T long distance network).

The mobile terminal 112 may be any one of a number of devices, such as a cell phone, a personal data assistant (PDA), a laptop computer, etc. It is well known that within the coverage area of the base station 110 there may exist one or more areas of RF degradation (such as area 114 which may be referred to as an “RF hole”). In such RF holes the RF may be degraded to the point that the mobile terminal cannot receive calls.

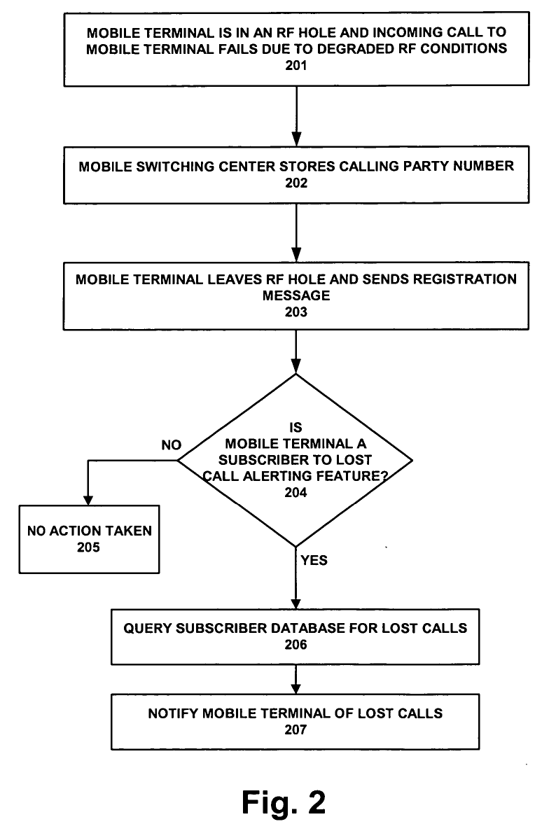

FIG. 2 is a representation of one exemplary flow diagram depicting an embodiment for network support for lost call alerting in the FIG. 1 apparatus. In this embodiment the mobile terminal may be in an RF hole and an incoming call to the mobile terminal may be unable to be completed due to degraded RF conditions (201). The network detects the failed call attempt and the reason for failure (degraded RF condition of called party mobile terminal) and stores the calling party number in the subscriber database associated with the called party (mobile terminal) (202). When the RF conditions of the called mobile terminal improve (for example the mobile terminal has move out of the RF hole), the called mobile terminal automatically sends a registration message to the network (203). When the network detects the registration message, the network checks if the mobile terminal is a subscriber to the service (204). If the mobile terminal is not a subscriber, then no action is taken (205). If the mobile terminal is a subscriber, the network checks the subscriber database for any lost call data that has been stored for this mobile terminal (206). If any calls were lost, the network forwards the lost call data to the called mobile terminal and clears the lost call log (207) for the mobile terminal.

Various information may be supplied to the mobile terminal in addition to the calling number. Such information may be supplied from information stored in the subscriber database and/or other storage locations. The mobile terminal may be notified by messages, audible tones or sounds, etc.

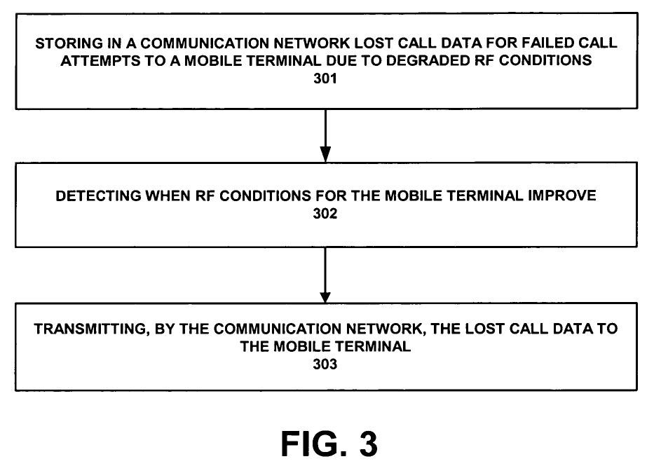

FIG. 3 is another representation, in more general terms, of one exemplary flow diagram for lost call alerting according to the present method. This embodiment of the method may have the steps of: storing in a communication network lost call data for failed call attempts to a mobile terminal due to degraded RF conditions (301); detecting when RF conditions for the mobile terminal improve (302); and transmitting, by the communication network, the lost call data to the mobile terminal (303).

Embodiments of the present method and apparatus overcome the drawbacks of the prior art regarding mobile phone coverage by enhancing the network to store failed call attempts due to poor RF conditions and to alert the mobile subscriber by SMS or automated voice message of those incoming call attempts that were lost. In this way for example, important call attempts to the mobile subscriber are not lost.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus comprising:
lost call alerting functionality in a communication network that later alerts a mobile terminal of calls which could not be delivered because the mobile terminal was located in an area of RF degradation when the delivery of the call was attempted; and
a storage for lost call data in the communication network.

2. The apparatus according to claim 1, wherein the storage is a subscriber database, wherein the communication network has a mobile switching center operatively coupled to a subscriber database, and wherein the lost call alerting functionality is part of the mobile switching center.

3. The apparatus according to claim 2, wherein the lost call data is indicative of a missed call to the mobile terminal due to RF (radio frequency) degradation.

4. The apparatus according to claim 3, wherein the lost call data comprises at least a number of a missed call, and wherein the mobile switching center supplies a number of the missed call to the mobile terminal when the mobile terminal is in communication with the mobile switching center.

5. The apparatus according to claim 1, wherein the mobile terminal is a cell phone.

6. The apparatus according to claim 1, wherein the mobile terminal is operatively coupled to the mobile switching center via a base station, wherein the base station has an area of coverage, and wherein the area of coverage has at least one RF hole with RF degradation.

7. An apparatus, comprising:
a mobile switching center operatively coupled to a subscriber database;
a base station operatively coupled to the mobile switching center;
a mobile terminal operatively coupled to the mobile switching center via the base station;
a lost call alerting functionality operatively coupled to the mobile switching center; and
lost call data stored in the subscriber database, the lost call data being indicative of a missed call to the mobile terminal due to RF (radio frequency) degradation.

8. The apparatus according to claim 7, wherein the lost call alerting functionality is part of the mobile switching center.

9. The apparatus according to claim 7, wherein the mobile terminal is a cell phone.

10. The apparatus according to claim 7, wherein the lost call data comprises at least a number of the missed call, and wherein the mobile switching center supplies the number of the missed call when the mobile terminal is in communication with the mobile switching center.

11. The apparatus according to claim 7, wherein the base station has an area of coverage, and wherein the area of coverage has at least one RF hole with RF degradation.

12. A method, comprising:
detecting, by a communication network, a failed call attempt to a mobile terminal due to degraded RF (radio frequency) conditions;
storing a calling party number of the failed call attempt in a storage in the communication network;
sending, when RF conditions of the called mobile terminal improve, a registration message from the called mobile terminal to the communication network;
detecting, by the communication network, the registration message;
checking, by the communication network, the storage for any lost call data that has been stored for this mobile terminal; and
forwarding, by the communication network, if any calls were lost, the lost call data to the called mobile terminal.

13. The method according to claim 12, wherein the method further comprises:
checking, by the communication network, if the mobile terminal is a subscriber to a call alerting service;
taking no action if the mobile terminal is not a subscriber; and
checking, by the communication network, when the mobile terminal is a subscriber, the storage for any lost call data that has been stored for this mobile terminal;

14. The method according to claim 12, wherein the storage is a subscriber database.

15. The method according to claim 12, wherein the mobile terminal is a cell phone.

16. The method according to claim 12, wherein lost call alerting functionality is part of a mobile switching center that is operatively coupled to the mobile terminal.

17. The method according to claim 16, wherein the lost call data comprises at least a number of the missed call, and wherein the mobile switching center supplies the number of the missed call when the mobile terminal is in communication with the mobile switching center.

18. The method according to claim 16, wherein the mobile terminal is operatively coupled to the mobile switching center via a base station, wherein the base station has an area of coverage, and wherein the area of coverage has at least one RF hole with RF degradation.

19. A method comprising:
storing in a communication network lost call data for failed call attempts to a mobile terminal due to degraded RF (radio frequency) conditions;
detecting when RF conditions for the mobile terminal improve; and
transmitting, by the communication network, the lost call data to the mobile terminal.

20. The method according to claim 19, wherein the storage is a subscriber database, and wherein the lost call data comprises at least a number of the failed call.

21. The method according to claim 19, wherein, when the RF conditions of associated with the mobile terminal improve, the mobile terminal automatically sends a registration message to the communication network.
